(19) United States
(12) Patent Application Publication
(10) Pub. No.: US 2018/0054613 A1
(43) Pub. Date: Feb. 22, 2018

(54) VIDEO ENCODING METHOD AND APPARATUS WITH IN-LOOP FILTERING PROCESS NOT APPLIED TO RECONSTRUCTED BLOCKS LOCATED AT IMAGE CONTENT DISCONTINUITY EDGE AND ASSOCIATED VIDEO DECODING METHOD AND APPARATUS

(71) Applicant: MEDIATEK INC., Hsin-Chu (TW)

(72) Inventors: Jian-Liang Lin, Yilan County (TW); Hung-Chih Lin, Nantou County (TW); Shen-Kai Chang, Hsinchu County (TW)

(21) Appl. No.: 15/675,810

(22) Filed: Aug. 14, 2017

Related U.S. Application Data
(60) Provisional application No. 62/377,762, filed on Aug. 22, 2016.

(51) Int. Cl. H04N 19/117; H04N 19/91; H04N 19/172

(52) U.S. Cl. CPC H04N 19/117; H04N 19/105; H04N 19/172; H04N 19/91

(57) ABSTRACT

A video encoding method includes: generating reconstructed blocks for coding blocks within a frame, respectively, wherein the frame has a 360-degree image content represented by projection faces arranged in a 360-degree Virtual Reality (360 VR) projection layout, and there is at least one image content discontinuity edge resulting from packing of the projection faces in the frame; and configuring at least one in-loop filter, such that the at least one in-loop filter does not apply in-loop filtering to reconstructed blocks located at the least one image content discontinuity edge.

### CROSS REFERENCE TO RELATED APPLICATIONS

This application claims the benefit of U.S. 62/377,762, filed on Aug. 22, 2016 and incorporated herein by reference.

### BACKGROUND

The present invention relates to video encoding and video decoding, and more particularly, to video encoding method and apparatus with an in-loop filtering process not applied to reconstructed blocks located at an image content discontinuity edge and associated video decoding method and apparatus.

The conventional video coding standards generally adopt a block based coding technique to exploit spatial and temporal redundancy. For example, the basic approach is to divide a source frame into a plurality of blocks, perform intra prediction/inter prediction on each block, transform residues of each block, and perform quantization and entropy encoding. Besides, a reconstructed frame is generated to provide reference pixel data used for coding following blocks. For certain video coding standards, in-loop filter(s) may be used for enhancing the image quality of the reconstructed frame. A video decoder is used to perform an inverse operation of a video encoding operation performed by a video encoder. For example, a reconstructed frame is generated in the video decoder to provide reference pixel data used for decoding following blocks, and in-loop filter(s) is used by the video decoder for enhancing the image quality of the reconstructed frame.

Virtual reality (VR) with head-mounted displays (HMDs) is associated with a variety of applications. The ability to show wide field of view content to a user can be used to provide immersive visual experiences. A real-world environment has to be captured in all directions resulting in an omnidirectional video corresponding to a viewing sphere. With advances in camera rigs and HMDs, the delivery of VR content may soon become the bottleneck due to the high bitrate required for representing such a 360-degree image content. When the resolution of the omnidirectional video is 4 K or higher, data compression/encoding is critical to reducing the bitrate.

In conventional video coding, the block boundary artifacts resulting from coding error can be greatly removed by using an in-loop filtering process to accomplish higher subjective and objective quality. However, it is possible that a frame with a 360-degree image content has image content discontinuity edges that are not caused by coding errors. The conventional in-loop filtering process does not detect such discontinuity. As a result, these discontiunuity edges may be locally blurred by the in-loop filtering process, resulting in undesired image quality degradation.

### SUMMARY

One of the objectives of the claimed invention is to provide video encoding method and apparatus with an in-loop filtering process not applied to reconstructed blocks located at an image content discontinuity edge and associated video decoding method and apparatus.

According to a first aspect of the present invention, an exemplary video encoding method is disclosed. The exemplary video encoding method includes: generating reconstructed blocks for coding blocks within a frame, respectively, wherein the frame has a 360-degree image content represented by projection faces arranged in a 360-degree Virtual Reality (360 VR) projection layout, and there is at least one image content discontinuity edge resulting from packing of the projection faces in the frame; and configuring at least one in-loop filter, such that the at least one in-loop filter does not apply in-loop filtering to reconstructed blocks located at the least one image content discontinuity edge.

According to a second aspect of the present invention, an exemplary video decoding method is disclosed. The exemplary video decoding method includes: generating reconstructed blocks for coding blocks within a frame, respectively, wherein the frame has a 360-degree image content represented by projection faces arranged in a 360-degree Virtual Reality (360 VR) projection layout, and there is at least one image content discontinuity edge resulting from packing of the projection faces in the frame; and configuring at least one in-loop filter, such that the at least one in-loop filter does not apply in-loop filtering to reconstructed blocks located at the least one image content discontinuity edge.

According to a third aspect of the present invention, an exemplary video encoder is disclosed. The exemplary video encoder includes an encoding circuit and a control circuit. The encoding circuit includes a reconstruction circuit and at least one in-loop filter. The reconstruction circuit is arranged to generate reconstructed blocks for coding blocks within a frame, respectively, wherein the frame has a 360-degree image content represented by projection faces arranged in a 360-degree Virtual Reality (360 VR) projection layout, and there is at least one image content discontinuity edge resulting from packing of the projection faces in the frame. The control circuit is arranged to configure the at least one in-loop filter, such that the at least one in-loop filter does not apply in-loop filtering to reconstructed blocks located at the least one image content discontinuity edge.

According to a fourth aspect of the present invention, an exemplary video decoder is disclosed. The exemplary video decoder includes a reconstruction circuit and at least one in-loop filter. The reconstruction circuit is arranged to generate reconstructed blocks for coding blocks within a frame, respectively, wherein the frame has a 360-degree image content represented by projection faces arranged in a 360-degree Virtual Reality (360 VR) projection layout, and there is at least one image content discontinuity edge resulting from packing of the projection faces in the frame. The at least one in-loop filter does not apply in-loop filtering to reconstructed blocks located at the least one image content discontinuity edge.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a video encoder according to an embodiment of the present invention.

FIG. 2 is a diagram illustrating a video decoder according to an embodiment of the present invention.

FIG. 3 is a diagram illustrating a cubemap projection (CMP) according to an embodiment of the present invention.

FIG. 4 is a diagram illustrating a 1×6 cubic format according to an embodiment of the present invention.

FIG. 5 is a diagram illustrating a 2×3 cubic format according to an embodiment of the present invention.

FIG. 6 is a diagram illustrating a 3×2 cubic format according to an embodiment of the present invention.

FIG. 7 is a diagram illustrating a 6×1 cubic format according to an embodiment of the present invention.

FIG. 8 is a diagram illustrating another 2×3 cubic format according to an embodiment of the present invention.

FIG. 9 is a diagram illustrating another 3×2 cubic format according to an embodiment of the present invention.

FIG. 10 is a diagram illustrating another 6×1 cubic format according to an embodiment of the present invention.

FIG. 11 is a diagram illustrating yet another 6×1 cubic format according to an embodiment of the present invention.

FIG. 12 is a diagram illustrating a result of controlling an in-loop filtering process applied to a frame according to an embodiment of the present invention.

FIG. 13 is a diagram illustrating a segmented sphere projection (SSP) according to an embodiment of the present invention.

FIG. 14 is a diagram illustrating one partitioning design of a 360 VR projection layout of projection faces produced by SSP according to an embodiment of the present invention.

FIG. 15 is a diagram illustrating another partitioning design of a 360 VR projection layout of projection faces produced by SSP according to an embodiment of the present invention.

FIG. 16 is a diagram illustrating a current prediction block and a plurality of neighboring prediction blocks according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

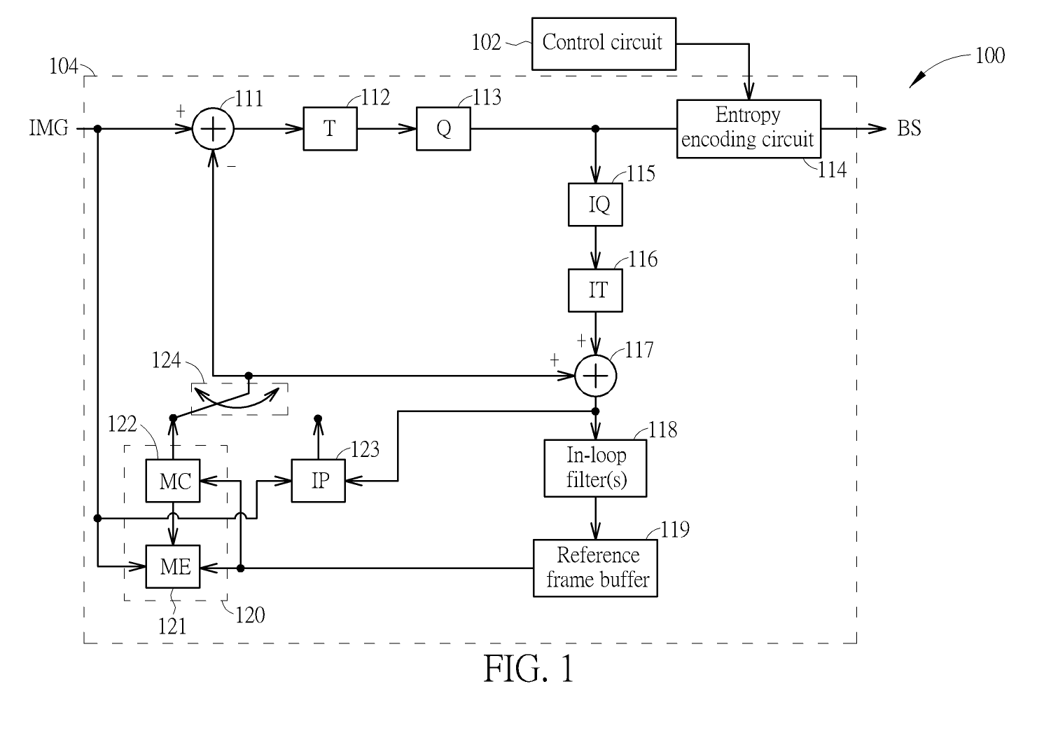

FIG. 1 is a diagram illustrating a video encoder according to an embodiment of the present invention. It should be noted that the video encoder architecture shown in FIG. 1 is for illustrative purposes only, and is not meant to be a limitation of the present invention. The video encoder 100 is arranged to encode a frame IMG to generate a bitstream BS as an output bitstream. For example, the frame IMG may be generated from a video capture device such as an omnidirectional camera. As shown in FIG. 1, the video encoder 100 includes a control circuit 102 and an encoding circuit 104. The control circuit 102 provides encoder control over processing blocks of the encoding circuit 104. For example, the control circuit 102 may decide the encoding parameters (e.g., control syntax elements) for the encoding circuit 104, where the encoding parameters (e.g., control syntax elements) are signaled to a video decoder via the bitstream BS generated from the video encoder 100. Concerning the encoding circuit 104, it includes a residual calculation circuit 111, a transform circuit (denoted by “T”) 112, a quantization circuit (denoted by “Q”) 113, an entropy encoding circuit (e.g., a variable length encoder) 114, an inverse quantization circuit (denoted by “IQ”) 115, an inverse transform circuit (denoted by “IT”) 116, a reconstruction circuit 117, at least one in-loop filter 118, a reference frame buffer 119, an inter prediction circuit 120 (which includes a motion estimation circuit (denoted by “ME”) 121 and a motion compensation circuit (denoted by “MC”) 122), an intra prediction circuit (denoted by “IP”) 123, and an intra/inter mode selection switch 124. The residual calculation circuit 111 is used for subtracting a predicted block from a current block to be encoded to generate residual of the current block to the following transform circuit 112. The predicted block may be generated from the intra prediction circuit 123 when the intra/inter mode selection switch 224 is controlled by an intra prediction mode selected, and may be generated from the inter prediction circuit 120 when the intra/inter mode selection switch 124 is controlled by an inter prediction mode selected. After being sequentially processed by the transform circuit 112 and the quantization circuit 113, the residual of the current block is converted into quantized transform coefficients, where the quantized transform coefficients are entropy encoded at the entropy encoding circuit 114 to be a part of the bitstream BS.

The encoding circuit 104 has an internal decoding circuit. Hence, the quantized transform coefficients are sequentially processed via the inverse quantization circuit 115 and the inverse transform circuit 116 to generate decoded residual of the current block to the following reconstruction circuit 117. The reconstruction circuit 117 combines the decoded residual of the current block and the predicted block of the current block to generate a reconstructed block of a reference frame (which is a reconstructed frame) stored in the reference frame buffer 119. The inter prediction circuit 120 may use one or more reference frames in the reference frame buffer 119 to generate the predicted block under inter prediction mode. Before the reconstructed block is stored into the reference frame buffer 119, the in-loop filter(s) 118 may perform designated in-loop filtering upon the reconstructed block. For example, the in-loop filter(s) 118 may include a deblocking filter (DBF), a sample adaptive offset (SAO) filter, and/or an adaptive loop filter (ALF).

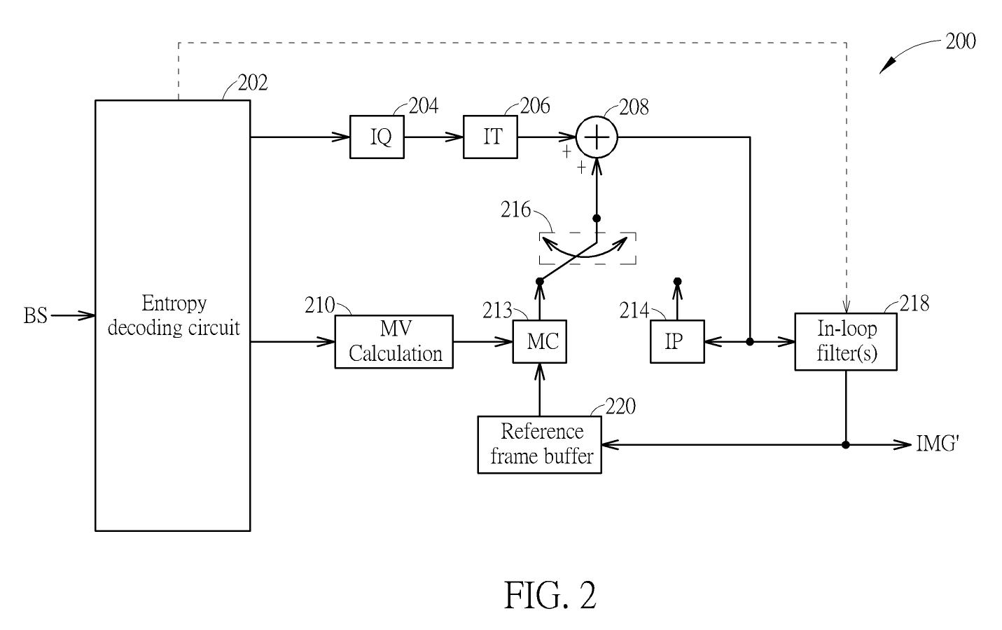

FIG. 2 is a diagram illustrating a video decoder according to an embodiment of the present invention. The video decoder 200 may communicate with a video encoder (e.g., video encoder 100 shown in FIG. 1) via a transmission means such as a wired/wireless communication link or a storage medium. In this embodiment, the video decoder 200 is arranged to receive the bitstream BS as an input bitstream and decode the received bitstream BS to generate a decoded frame IMG′. For example, the decoded frame IMG′ may be displayed on a display device such as a head-mounted display. It should be noted that the video decoder architecture shown in FIG. 2 is for illustrative purposes only, and is not meant to be a limitation of the present invention. As shown in FIG. 2, the video decoder 200 is a decoding circuit that includes an entropy decoding circuit (e.g., a variable length decoder) 202, an inverse quantization circuit (denoted by “IQ”) 204, an inverse transform circuit (denoted by “IT”) 206, a reconstruction circuit 208, a motion vector calculation circuit (denoted by “MV Calculation”) 210, a motion compensation circuit (denoted by “MC”) 213, an intra prediction circuit (denoted by “IP”) 214, an intra/inter mode selection switch 216, at least one in-loop filter 218, and a reference frame buffer 220.

When a block is inter-coded, the motion vector calculation circuit 210 refers to information parsed from the bitstream BS by the entropy decoding circuit 202 to determine a motion vector between a current block of the frame being decoded and a predicted block of a reference frame that is a reconstructed frame and stored in the reference frame buffer 220. The motion compensation circuit 213 may perform interpolation filtering to generate the predicted block according to the motion vector. The predicted block is supplied to the intra/inter mode selection switch 216. Since the block is inter-coded, the intra/inter mode selection switch 216 outputs the predicted block generated from the motion compensation circuit 213 to the reconstruction circuit 208.

When a block is intra-coded, the intra prediction circuit 214 generates the predicted block to the intra/inter mode selection switch 216. Since the block is intra-coded, the intra/inter mode selection switch 216 outputs the predicted block generated from the intra prediction circuit 214 to the reconstruction circuit 208.

In addition, decoded residual of the block is obtained through the entropy decoding circuit 202, the inverse quantization circuit 204, and the inverse transform circuit 206. The reconstruction circuit 208 combines the decoded residual and the predicted block to generate a reconstructed block. The reconstructed block may be stored into the reference frame buffer 220 to be a part of a reference frame (which is a reconstructed frame) that may be used for decoding following blocks. Similarly, before the reconstructed block is stored into the reference frame buffer 220, the in-loop filter(s) 218 may perform designated in-loop filtering upon the reconstructed block. For example, the in-loop filter(s) 218 may include a DBF, an SAO filter, and/or an ALF.

For clarity and simplicity, the following assumes that the in-loop filter 118 implemented in the video encoder 100 and the in-loop filter 218 implemented in the video decoder 200 are deblocking filters.

In other words, the terms “in-loop filter” and “deblocking filter” may be interchangeable in the present invention. However, this is not meant to be a limitation of the present invention. In practice, the same in-loop control scheme proposed by the present invention may also be applied to other in-loop filters, such as an SAO filter and an ALF. These alternative designs all fall within the scope of the present invention.

The deblocking filter 118/218 is applied to reconstructed samples before writing them into the reference frame buffer 119/220 in the video encoder 100/video decoder 200. For example, the deblocking filter 118/218 is applied to all reconstructed samples at a boundary of each transform block except the case where the boundary is also a frame boundary. For example, concerning a transform block, the deblocking filter 118/218 is applied to all reconstructed samples at a left vertical edge (i.e., left boundary) of the transform block when the left vertical edge is not a left vertical edge (i.e., left boundary) of a frame, and is also applied to all reconstructed samples at a top horizontal edge (i.e., top boundary) of the transform block when the top horizontal edge is not a top horizontal edge (i.e., top boundary) of the frame. To filter reconstructed samples at the left vertical edge (i.e., left boundary) of the transform block, the deblocking filter 118/218 requires reconstructed samples on both sides of the left vertical edge. Hence, reconstructed samples belonging to the transform block and reconstructed samples belonging to left neighboring transform block(s) are needed by vertical edge filtering of the deblocking filter 118/218. Similarly, to filter reconstructed samples at the top horizontal edge (i.e., top boundary) of the transform block, the deblocking filter 118/218 requires reconstructed samples on both sides of the top horizontal edge. Hence, reconstructed samples belonging to the transform block and reconstructed samples belonging to upper neighboring transform block(s) are needed by horizontal edge filtering of the deblocking filter 118/218. One coding block may be divided into one or more transform blocks, depending upon the transform size(s) used. Hence, a left vertical edge (i.e., left boundary) of the coding block is aligned with left vertical edge(s) of transform block(s) included in the coding block, and a top horizontal edge (i.e., top boundary) of the coding block is aligned with top vertical edge(s) of transform block(s) included in the coding block. Hence, concerning deblocking filtering of a coding block, there is data dependency between the coding block and adjacent coding block(s). However, when an edge between two coding blocks is not caused by coding errors, applying deblocking filtering to the edge will lead to a blurred edge. The present invention proposes an in-loop filter control scheme to prevent the in-loop filter 118/218 from applying an in-loop filter process to an edge that is caused by packing of projection faces rather than caused by coding errors.

In this embodiment, the frame IMG to be encoded by the video encoder 100 has a 360-degree image content represented by projection faces arranged in a 360-degree Virtual Reality (360 VR) projection layout. Hence, after the bitstream BS is decoded by the video decoder 200, the decoded frame (i.e., reconstructed frame) IMG′ also has a 360-degree image content represented by projection faces arranged in the same 360 VR projection layout. The projection faces are packed to form the frame IMG. To achieve better compression efficiency, the employed 360 VR projection layout may have the projection faces packed with proper permutation and/or rotation to maximally achieve continuity between different projection faces. However, due to inherent characteristics of the 360-degree image content and the projection format, there is at least one image content discontinuity edge resulting from packing of the projection faces in the frame IMG.

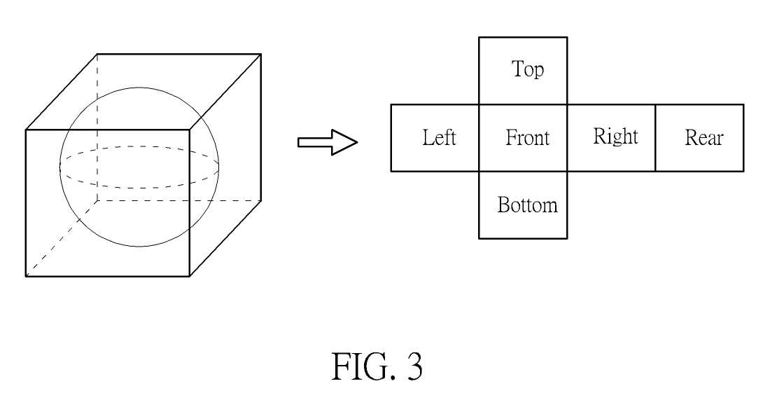

FIG. 3 is a diagram illustrating a cubemap projection (CMP) according to an embodiment of the present invention. In this example, the 360 VR projection employs CMP to produce six cubic faces (denoted by “Left”, “Front”, “Right”, “Rear”, “Top”, and “Bottom”) as projection faces. A 360-degree image content (which may be captured by an omnidirectional camera) is represented by the six cubic faces. In accordance with a selected 360 VR projection layout, the six cubic faces are properly packed to form the frame IMG.

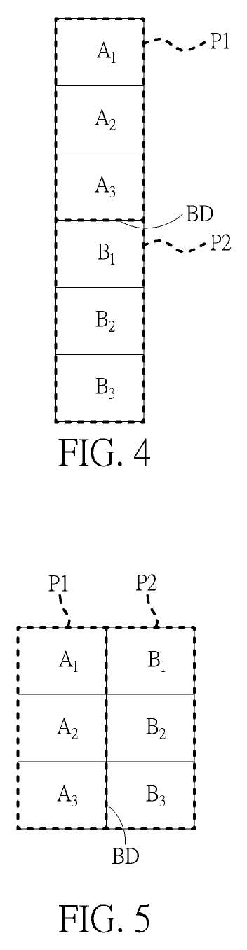

FIG. 4 is a diagram illustrating a 1×6 cubic format according to an embodiment of the present invention. With proper permutation and/or rotation of six cubic faces produced by CMP, the cubic faces A₁, A₂, A₃ have continuous image contents, and the cubic faces B₁, B₂, B₃ have continuous image contents. However, due to packing of the six cubic faces in the 1×6 cubic format, there is an image content discontinuity edge (horizontal edge) BD between the adjacent cubic faces A₃ and B₁.

FIG. 5 is a diagram illustrating a 2×3 cubic format according to an embodiment of the present invention. With proper permutation and/or rotation of six cubic faces produced by CMP, the cubic faces A₁, A₂, A₃ have continuous image contents, and the cubic faces B₁, B₂, B₃ have continuous image contents. However, due to packing of the six cubic faces in the 2×3 cubic format, there is an image content discontinuity edge (vertical edge) BD between the adjacent cubic faces A₁-A₃ and B₁-B₃.

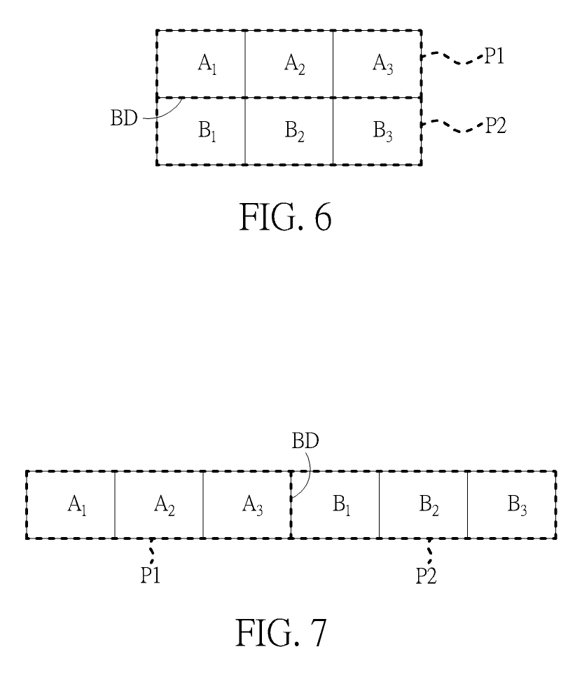

FIG. 6 is a diagram illustrating a 3×2 cubic format according to an embodiment of the present invention. With proper permutation and/or rotation of six cubic faces produced by CMP, the cubic faces A₁, A₂, A₃ have continuous image contents, and the cubic faces B₁, B₂, B₃ have continuous image contents. However, due to packing of the six cubic faces in the 3×2 cubic format, there is an image content discontinuity edge (horizontal edge) BD between the adjacent cubic faces A₁-A₃ and B₁-B₃.

FIG. 7 is a diagram illustrating a 6×1 cubic format according to an embodiment of the present invention. With proper permutation and/or rotation of six cubic faces produced by CMP, the cubic faces A₁, A₂, A₃ have continuous image contents, and the cubic faces B₁, B₂, B₃ have continuous image contents. However, due to packing of the six cubic faces in the 6×1 cubic format, there is an image content discontinuity edge (vertical edge) BD between the adjacent cubic faces A₃ and B₁.

FIG. 8 is a diagram illustrating another 2×3 cubic format according to an embodiment of the present invention. With proper permutation and/or rotation of six cubic faces produced by CMP, the cubic faces A₁, A₂, A₃ have continuous image contents, and the cubic faces B₁, B₂, B₃ have continuous image contents. However, due to packing of the six cubic faces in the 2×3 cubic format, there is an image content discontinuity edge BD between the adjacent cubic faces A₁, A₃ and B₁, B₃.

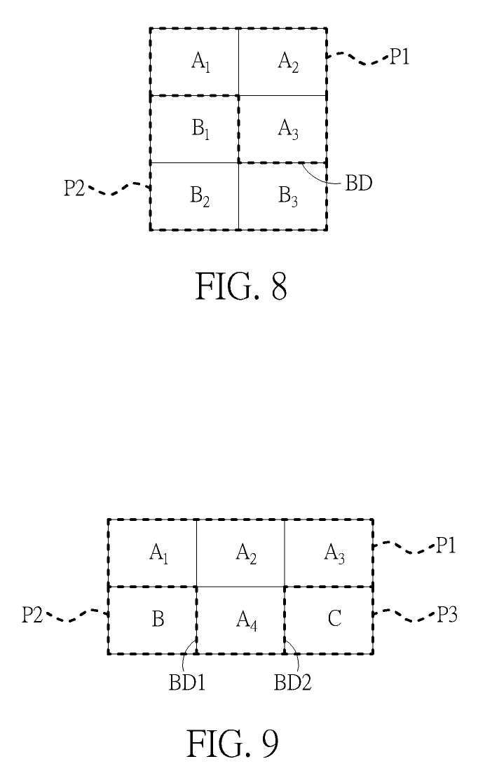

FIG. 9 is a diagram illustrating another 3×2 cubic format according to an embodiment of the present invention. With proper permutation and/or rotation of six cubic faces produced by CMP, the cubic faces A₁, A₂, A₃, A₄ have continuous image contents. However, due to packing of the six cubic faces in the 3×2 cubic format, one image content discontinuity edge BD1 is between the adjacent cubic faces A₁, A₄ and B, and another image content discontinuity edge BD2 is between the adjacent cubic faces A₃, A₄ and C.

If reconstructed blocks at the image content discontinuity edge resulting from packing of the projection faces are processed by the in-loop filtering process (e.g., deblocking filtering process, SAO filtering process, and/or ALF process), the image content discontinuity edge (which is not caused by coding errors) may be locally blurred by the in-loop filtering process. The present invention proposes an in-loop filter control scheme which disables the in-loop filtering process at the image content discontinuity edge resulting from packing of the projection faces. The control circuit 102 of the video encoder 100 is used to set control syntax element(s) of the in-loop filter(s) 118 to configure the in-loop filter(s) 118, such that the in-loop filter(s) 118 do not apply in-loop filtering to reconstructed blocks located at the image content discontinuity edge resulting from packing of the projection faces. Since the control syntax element(s) are embedded in the bitstream BS, the video decoder 200 can derive the signaled control syntax element(s) at the entropy decoding circuit 202. The in-loop filter(s) 218 at the video decoder 200 can be configured by the signaled control syntax element(s), such that the in-loop filter(s) 218 also do not apply in-loop filtering to reconstructed blocks located at the image content discontinuity edge resulting from packing of the projection faces.

An existing tool available in a video coding standard (e.g., H.264, H.265, or VP9) can be used to disable an in-loop filtering process across slice/tile/segment boundary. When a slice/tile/segment boundary is also an image content discontinuity edge resulting from packing of the projection faces, the in-loop filtering process can be disabled at the image content discontinuity edge by using the existing tool without any additional changes made to the video encoder 100 and the video decoder 200. In this embodiment, the control circuit 102 of the video encoder 100 may further divide the frame IMG into a plurality of partitions for independent partition coding. In a case where the video encoder 100 is an H.264 encoder, each partition is a slice. In another case where the video encoder 100 is an H.265 encoder, each partition is a slice or a tile. In yet another case where the video encoder 100 is a VP9 encoder, each partition is a tile or a segment.

As shown in FIG. 4, the frame IMG formed by cubic faces A₁-A₃ and B₁-B₃ arranged in the 1×6 cubic format is divided into a first partition P1 and a second partition P2, where a partition boundary between the adjacent partitions P1 and P2 is the image content discontinuity edge BD. For example, each of the first partition P1 and the second partition P2 may be a slice or tile.

As shown in FIG. 5, the frame IMG formed by cubic faces A₁-A₃ and B₁-B₃ arranged in the 2×3 cubic format is divided into a first partition P1 and a second partition P2, where a partition boundary between the adjacent partitions P1 and P2 is the image content discontinuity edge BD. For example, each of the first partition P1 and the second partition P2 may be a tile.

As shown in FIG. 6, the frame IMG formed by cubic faces A₁-A₃ and B₁-B₃ arranged in the 3×2 cubic format is divided into a first partition P1 and a second partition P2, where a partition boundary between the adjacent partitions P1 and P2 is the image content discontinuity edge BD. For example, each of the first partition P1 and the second partition P2 may be a slice or tile.

As shown in FIG. 7, the frame IMG formed by cubic faces A₁-A₃ and B₁-B₃ arranged in the 6×1 cubic format is divided into a first partition P1 and a second partition P2, where a partition boundary between the adjacent partitions P1 and P2 is the image content discontinuity edge BD. For example, each of the first partition P1 and the second partition P2 may be a tile.

It should be noted that the present invention has no limitations on the partitioning method employed by the control circuit 102 of the video encoder 100. Other partitioning method such as Flexible Macroblock Ordering (FMO) may be employed to define partitions of the frame IMG, as shown in FIGS. 8-11.

As shown in FIG. 8, the frame IMG formed by cubic faces A₁-A₃ and B₁-B₃ arranged in the 2×3 cubic format is divided into a first partition P1 and a second partition P2, where a partition boundary between the adjacent partitions P1 and P2 is the image content discontinuity edge BD.

As shown in FIG. 9, the frame IMG formed by cubic faces A₁-A₄, B and C arranged in the 3×2 cubic format is divided into a first partition P1, a second partition P2 and a third partition P3, where a partition boundary between the adjacent partitions P1 and P2 is the image content discontinuity edge BD1, and a partition boundary between the adjacent partitions P1 and P3 is the image content discontinuity edge BD2.

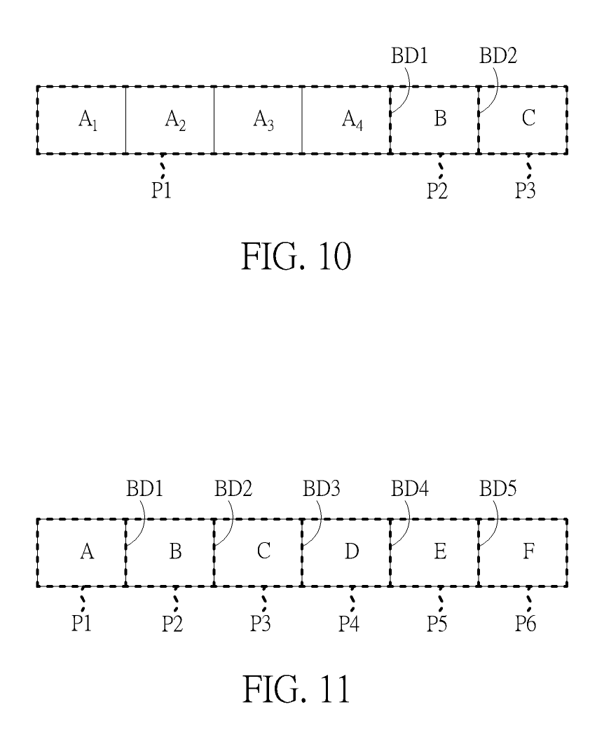

As shown in FIG. 10, the frame IMG formed by cubic faces A₁-A₄, B and C arranged in the 6×1 cubic format is divided into a first partition P1, a second partition P2 and a third partition P3, where a partition boundary between the adjacent partitions P1 and P2 is the image content discontinuity edge BD1, and a partition boundary between the adjacent partitions P2 and P3 is the image content discontinuity edge BD2.

As shown in FIG. 11, the frame IMG formed by cubic faces A-F arranged in the 6×1 cubic format is divided into a first partition P1, a second partition P2, a third partition P3, a fourth partition P4, a fifth partition P5 and a sixth partition P6, where a partition boundary between the adjacent partitions P1 and P2 is the image content discontinuity edge BD1, a partition boundary between the adjacent partitions P2 and P3 is the image content discontinuity edge BD2, a partition boundary between the adjacent partitions P3 and P4 is the image content discontinuity edge BD3, a partition boundary between the adjacent partitions P4 and P5 is the image content discontinuity edge BD4, and a partition boundary between the adjacent partitions P5 and P6 is the image content discontinuity edge BD5.

Since an existing tool available in a video coding standard (e.g., H.264, H.265, or VP9) can be used to disable an in-loop filtering process across slice/tile/segment boundary, the control circuit 102 can properly set control syntax element(s) to disable the in-loop filter(s) 118 at a partition boundary (which may be a slice boundary, a tile boundary or a segment boundary), such that no in-loop filtering is applied to reconstructed blocks located at an image content discontinuity edge (which is also the partition boundary). In addition, the control syntax element(s) used for controlling the in-loop filter(s) 118 at the video encoder 100 are signaled to the video decoder 200 via the bitstream BS, such that the in-loop filter(s) 218 at the video encoder 200 are controlled by the signaled control syntax element(s) to achieve the same objective of disabling an in-loop filtering process at the partition boundary.

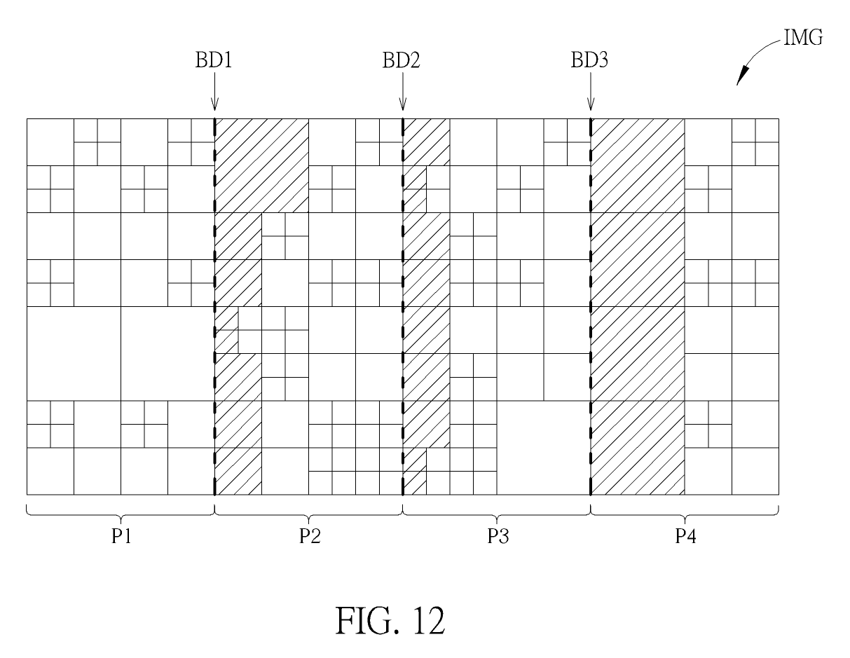

FIG. 12 is a diagram illustrating a result of controlling an in-loop filtering process applied to a frame according to an embodiment of the present invention. In this example, the control circuit 102 may divide the frame IMG into four partitions (e.g., tiles) P1, P2, P3, P4 arranged horizontally for independent encoding at the video encoder 100 and independent decoding at the video decoder 200. The frame IMG is formed by packing of projection faces. In this example, a partition boundary between adjacent partitions P1 and P2 is a first image content discontinuity edge BD1 resulting from packing of projection faces, a partition boundary between adjacent partitions P2 and P3 is a second image content discontinuity edge BD2 resulting from packing of projection faces, and a partition boundary between adjacent partitions P3 and P4 is a third image content discontinuity edge BD3 resulting from packing of projection faces.

The control circuit 102 further divides each of the partitions P1-P4 into coding blocks. The control circuit 102 determines a coding block size of each first coding block located at a partition boundary between two adjacent partitions by an optimal coding block size selected from candidate coding block sizes (e.g., 64×64, 64×32, 32×64, 32×32, 32×16, 16×32, 16×16, . . . 8×8, etc.), and determines a coding block size of each second coding block not located at a partition boundary between two adjacent partitions by an optimal coding block size selected from candidate coding block sizes (e.g., 64×64, 64×32, 32×64, 32×32, 32×16, 16×32, 16×16, . . . 8×8, etc.). For example, among the candidate coding block sizes, the optimal coding block size makes a coding block have smallest distortion resulting from the block-based encoding. As shown in FIG. 12, reconstructed blocks of the first blocks (which are represented by shaded areas) are not processed by the in-loop filtering process, and reconstructed blocks of the second blocks (which are represented by un-shaded areas) are processed by the in-loop filtering process. In this way, the image quality is not degraded by applying in-loop filtering to image content discontinuity edges BD1, BD2, BD3 resulting from packing of projection faces.

The input formats of the frame IMG shown in FIGS. 4-11 are for illustrative purposes only, and are not meant to be limitations of the present invention. For example, the frame IMG may be generated by packing projection faces in a plane_poles_cubemap format or a plane_poles format, and the frame IMG may be divided into partitions according to image content discontinuity edge(s) resulting from packing of the projection faces in the alternative input format.

As shown in FIG. 3, the 360 VR projection employs CMP to produce six cubic faces as projection faces. Hence, a 360-degree image content (which may be captured by an omnidirectional camera) is represented by the six cubic faces, and the six cubic faces are properly packed to form the frame IMG. However, this is for illustrative purposes only, and is not meant to be a limitation of the present invention. In practice, the proposed in-loop filter control scheme maybe applied to a frame formed by packing projection faces obtained using other 360 VR projection.

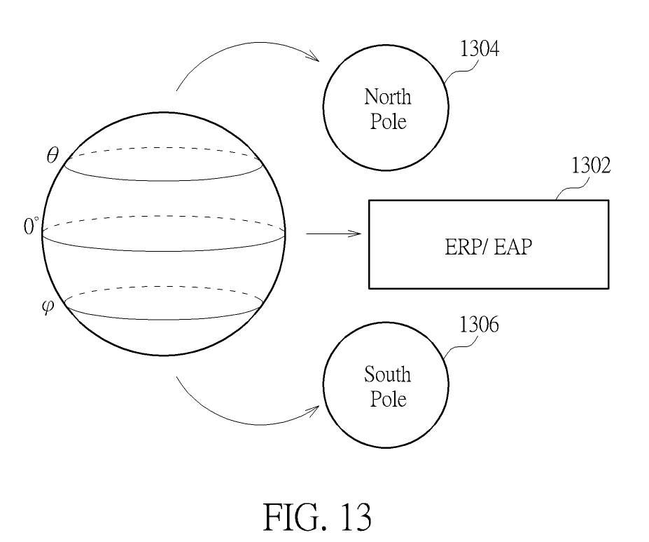

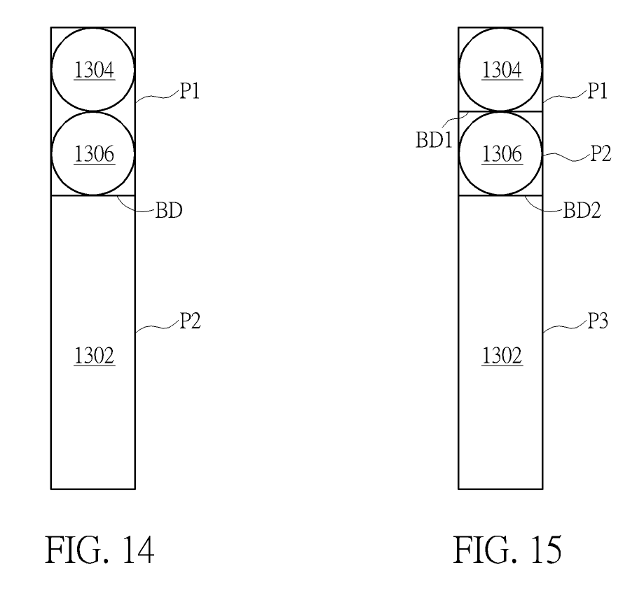

FIG. 13 is a diagram illustrating a segmented sphere projection (SSP) according to an embodiment of the present invention. In this example, the 360 VR projection employs SSP to produce projection faces 1302, 1304 and 1306. A 360-degree image content (which may be captured by an omnidirectional camera) is represented by the projection faces 1302, 1304 and 1306, where the projection face 1304 contains an image content of the north pole region, the projection face 1306 contains an image content of the south pole region, and the projection face 1302 is an equirectangular projection (ERP) result of the equator region or an equal-area projection (EAP) result of the equator region. In accordance with a selected 360 VR projection layout shown in FIG. 14, the projections faces are properly packed to form the frame IMG. Due to inherent characteristic of SSP, each of the projection faces 1302, 1304, 1306 has continuous image contents. However, due to packing of the projection faces 1302, 1304, 1306 in the format shown in FIG. 14, there is an image content discontinuity edge (horizontal edge) BD between the adjacent projection faces 1302 and 1306.

As mentioned above, an existing tool available in a video coding standard (e.g., H.264, H.265, or VP9) can be used to disable an in-loop filtering process cross slice/tile/segment boundary. When a slice/tile/segment boundary is also an image content discontinuity edge resulting from packing of the projection faces, the in-loop filtering process can be disabled at the image content discontinuity edge by using the existing tool without any additional changes made to the video encoder 100 and the video decoder 200. As shown in FIG. 14, the control circuit 102 divides the frame IMG into a first partition P1 and a second partition P2, where a partition boundary between the adjacent partitions P1 and P2 is the image content discontinuity edge BD. For example, each of the first partition P1 and the second partition P2 may be a slice or tile.

Alternatively, due to packing of the projection faces 1302, 1304, 1306 in the format shown in FIG. 15, one image content discontinuity edge (horizontal edge) BD1 exists between the adjacent projection faces 1304 and 1306, and another image content discontinuity edge (horizontal edge) BD2 exists between the adjacent projection faces 1302 and 1306. As shown in FIG. 15, the control circuit 102 divides the frame IMG into a first partition P1, a second partition P2, and a third partition P3, where a partition boundary between the adjacent partitions P1 and P2 is the image content discontinuity edge BD1, and a partition boundary between the adjacent partitions P2 and P3 is the image content discontinuity edge BD2 For example, each of the first partition P1, the second partition P2 and the third partition P3 may be a slice or tile.

The control circuit 102 may further divide one coding block into one or more prediction blocks. There may be redundancy among motion vectors of neighboring prediction blocks in the same frame. If one motion vector of each prediction block is encoded directly, it may cost a large number of bits. Since motion vectors of neighboring prediction blocks may be correlated with each other, a motion vector of a neighboring block may be used to predict a motion vector of a current block, which is called motion vector predictor (MVP). Since the video decoder 200 can derive an MVP of a current block from a motion vector of a neighboring block, the video encoder 100 does not need to transmit the MVP of the current block to the video decoder 200, thus improving the coding efficiency.

The inter prediction circuit 120 of the video encoder 100 may be configured to select a final MVP of a current prediction block from candidate MVPs that are motion vectors possessed by neighboring prediction blocks. Similarly, the motion vector calculation circuit 210 of the video decoder 200 may be configured to select a final MVP of a current prediction block from candidate MVPs that are motion vectors possessed by neighboring prediction blocks. It is possible that a neighboring prediction block and a current prediction block are not located on the same side of an image content discontinuity edge. For example, a partition boundary between a first partition and a second partition in the same frame (e.g., a slice boundary between adjacent slices, a tile boundary between adjacent tiles, or a segment boundary between adjacent segments) is also an image content discontinuity edge resulting from packing of projection faces, and the current prediction and the neighboring prediction block are located at the first partition and the second partition, respectively. To avoid performing motion vector prediction cross an image content discontinuity edge, the present invention proposes treating a candidate MVP of the current prediction block that is a motion vector possessed by the neighboring prediction block as unavailable. Hence, the motion vector of the neighboring prediction block is not used as one candidate MVP of the current prediction block.

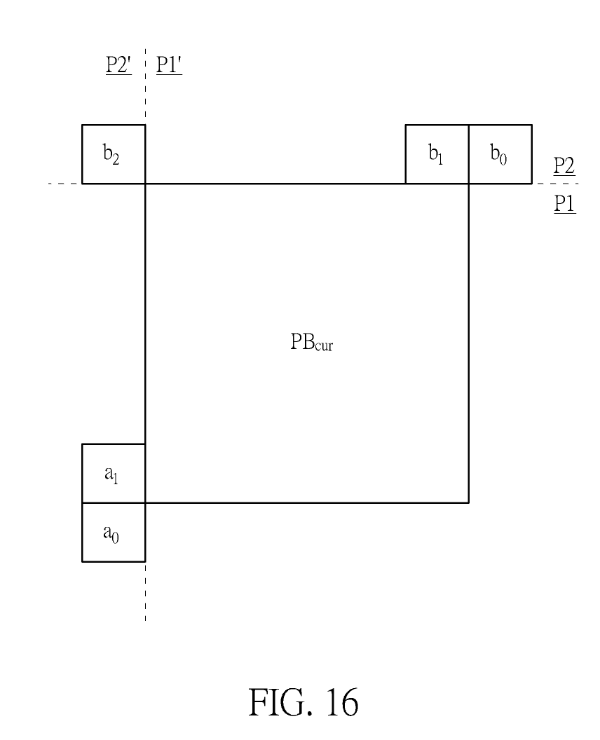

FIG. 16 is a diagram illustrating a current prediction block and a plurality of neighboring prediction blocks according to an embodiment of the present invention. The current prediction block PB_{cur} and neighboring prediction blocks a₀, a₁, b₀, b₁, b₂ are located in the same frame. In a case where a partition boundary between a first partition P1 and a second partition P2 is also an image content discontinuity edge resulting from packing of projection faces, candidate MVPs of the current prediction block PB_{cur} that are motion vectors possessed by neighboring prediction blocks b₀, b₁, b₂ are implicitly or explicitly treated as unavailable when determining a final MVP for the current prediction block. In another case where a partition boundary between a first partition P1′ and a second partition P2′ is also an image content discontinuity edge resulting from packing of projection faces, candidate MVPs of the current prediction block PB_{cur} that are motion vectors possessed by neighboring prediction blocks a₀, a₁, b₂ are implicitly or explicitly treated as unavailable when determining a final MVP for the current prediction block.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video encoding method comprising:
generating reconstructed blocks for coding blocks within a frame, respectively, wherein the frame has a 360-degree image content represented by projection faces arranged in a 360-degree Virtual Reality (360 VR) projection layout, and there is at least one image content discontinuity edge resulting from packing of the projection faces in the frame; and
configuring at least one in-loop filter, such that the at least one in-loop filter does not apply in-loop filtering to reconstructed blocks located at the least one image content discontinuity edge.

2. The video encoding method of claim 1, further comprising:
dividing the frame into a plurality of partitions according to the least one image content discontinuity edge, wherein each of the partitions comprises a plurality of coding blocks, each of the coding block comprises a plurality of pixels, and the at least one image content discontinuity edge comprises a partition boundary between adjacent partitions in the frame.

3. The video encoding method of claim 1, wherein each of the coding block includes one or more prediction blocks, and encoding the frame to generate the output bitstream further comprises:
when determining a final motion vector predictor (MVP) for a current prediction block in a coding block of the frame, treating a candidate MVP of the current prediction block that is a motion vector possessed by a neighboring prediction block as unavailable, wherein the current prediction block and the current prediction block are located on opposite sides of the at least one image content discontinuity edge.

4. The video encoding method of claim 1, wherein each of the partitions is a slice, or a tile, or a segment.

5. The video encoding method of claim 1, wherein the at least one in-loop filter comprises a deblocking filter, or a sample adaptive offset (SAO) filter, or an adaptive loop filter (ALF).

6. A video decoding method comprising:
generating reconstructed blocks for coding blocks within a frame, respectively, wherein the frame has a 360-degree image content represented by projection faces arranged in a 360-degree Virtual Reality (360 VR) projection layout, and there is at least one image content discontinuity edge resulting from packing of the projection faces in the frame; and
configuring at least one in-loop filter, such that the at least one in-loop filter does not apply in-loop filtering to reconstructed blocks located at the least one image content discontinuity edge.

7. The video decoding method of claim 6, wherein the frame is divided into a plurality of partitions, each of the partitions comprises a plurality of coding blocks, each of the coding block comprises a plurality of pixels, and the at least one image content discontinuity edge comprises a partition boundary between adjacent partitions in the frame.

8. The video decoding method of claim 6, wherein each of the coding block includes one or more prediction blocks, and decoding the input bitstream to reconstruct the frame further comprises:
when determining a final motion vector predictor (MVP) for a current prediction block in a coding block of the first partition, treating a candidate MVP of the current prediction block that is a motion vector possessed by a neighboring prediction block as unavailable, wherein the current prediction block and the current prediction block are located on opposite sides of the at least one image content discontinuity edge.

9. The video decoding method of claim 6, wherein each of the partitions is a slice, or a tile, or a segment.

10. The video decoding method of claim 6, wherein the at least one in-loop filter comprises a deblocking filter, or a sample adaptive offset (SAO) filter, or an adaptive loop filter (ALF).

11. A video encoder comprising:
an encoding circuit, comprising:
a reconstruction circuit, arranged to generate reconstructed blocks for coding blocks within a frame, respectively, wherein the frame has a 360-degree image content represented by projection faces arranged in a 360-degree Virtual Reality (360 VR) projection layout, and there is at least one image content discontinuity edge resulting from packing of the projection faces in the frame; and
at least one in-loop filter; and
a control circuit, arranged to configure the at least one in-loop filter, such that the at least one in-loop filter does not apply in-loop filtering to reconstructed blocks located at the least one image content discontinuity edge.

12. The video encoder of claim 11, wherein the control circuit is further arranged to divide the frame into a plurality of partitions according to the least one image content discontinuity edge, where each of the partitions comprises a plurality of coding blocks, each of the coding block comprises a plurality of pixels, and the at least one image content discontinuity edge comprises a partition boundary between adjacent partitions in the frame.

13. The video encoder of claim 11, wherein each of the coding block includes one or more prediction blocks; and when determining a final motion vector predictor (MVP) for a current prediction block in a coding block of the first partition, the encoding circuit treats a candidate MVP of the current prediction block that is a motion vector possessed by a neighboring prediction block as unavailable, wherein the current prediction block and the current prediction block are located on opposite sides of the at least one image content discontinuity edge.

14. The video encoder of claim 11, wherein each of the partitions is a slice, or a tile, or a segment.

15. The video encoder of claim 11, wherein the at least one in-loop filter comprises a deblocking filter, or a sample adaptive offset (SAO) filter, or an adaptive loop filter (ALF).

16. A video decoder comprising:
a reconstruction circuit, arranged to generate reconstructed blocks for coding blocks within a frame, respectively, wherein the frame has a 360-degree image content represented by projection faces arranged in a 360-degree Virtual Reality (360 VR) projection layout, and there is at least one image content discontinuity edge resulting from packing of the projection faces in the frame; and
at least one in-loop filter, wherein the at least one in-loop filter does not apply in-loop filtering to reconstructed blocks located at the least one image content discontinuity edge.

17. The video decoder of claim 16, wherein the frame is divided into a plurality of partitions, each of the partitions comprises a plurality of coding blocks, each of the coding block comprises a plurality of pixels, and the at least one image content discontinuity edge comprises a partition boundary between adjacent partitions in the frame.

18. The video decoder of claim 16, wherein each of the coding block includes one or more prediction blocks; and when determining a final motion vector predictor (MVP) for a current prediction block in a coding block of the first partition, the video decoder treats a candidate MVP of the current prediction block that is a motion vector possessed by a neighboring prediction block as unavailable, wherein the current prediction block and the current prediction block are located on opposite sides of the at least one image content discontinuity edge.

19. The video decoder of claim 16, wherein each of the partitions is a slice, or a tile, or a segment.

20. The video decoder of claim 16, wherein the at least one in-loop filter comprises a deblocking filter, or a sample adaptive offset (SAO) filter, or an adaptive loop filter (ALF).
